(19) United States
(12) Patent Application Publication
(10) Pub. No.: US 2008/0000318 A1
(43) Pub. Date: Jan. 3, 2008

(54) COMPRESSOR CRANKSHAFT, PARTICULARLY REFRIGERANT COMPRESSOR CRANKSHAFT, AND METHOD FOR GRINDING SUCH A CRANKSHAFT

(75) Inventors: Frank Holm Iversen, Padborg (DK); Heinz Otto Lassen, Flensburg (DE); Marten Nommensen, Flensburg (DE); Ekkehard Handke, Grossenwiehe (DE)

Correspondence Address: MCCORMICK, PAULDING & HUBER LLP, CITY PLACE II, 185 ASYLUM STREET, HARTFORD, CT, 06103, US

(73) Assignee: Danfoss Compressors GmbH, Flensburg (DE)

(21) Appl. No.: 11/770,005

(22) Filed: Jun. 28, 2007

(30) Foreign Application Priority Data
Jul. 1, 2006 (DE) 10 2006 030 492.6

(51) Int. Cl. F16C 3/04; B24B 7/00

(52) U.S. Cl. 74/595; 451/231

(57) ABSTRACT

The invention concerns a compressor crankshaft, particularly a refrigerant compressor crankshaft (1) and a method for manufacturing such a crankshaft, with a shaft element (2), a crank pin (9) located eccentrically to the shaft element and a transition element (7) between the shaft element (2) and the crank pin (9). The purpose of the invention is to keep the manufacturing costs low. For this purpose, it is ensured that along its circumference the transition element (7) has at least one first reference point (20) and one second reference point (21a, 21b), with which the transition element (7) can be positioned in a holding fixture (25) of a working machine.

### CROSS REFERENCE TO RELATED APPLICATIONS

Applicant hereby claims foreign priority benefits under U.S.C. § 119 from German Patent Application No. 10 2006 030 492.6 filed on Jul. 1, 2006, the contents of which are incorporated by reference herein.

### FIELD OF THE INVENTION

The invention concerns a compressor crankshaft, particularly a refrigerant compressor crankshaft, with a shaft element, a crank pin located eccentrically to the shaft element and a transition element between the shaft element and the crank pin. Further, the invention concerns a method for grinding a compressor crankshaft, particularly a refrigerant compressor crankshaft, with a shaft element, a crank pin and a transition element between the shaft element and the crank pin, the circumference of the shaft element being ground.

### BACKGROUND OF THE INVENTION

In the following the invention is described on the basis of a crankshaft meant for a refrigerant compressor.

Refrigerant compressors in the form of plunger piston compressors usually have a crankshaft, whose shaft element is connected in a non-rotatable manner to the rotor of a drive motor. The transition element rotating with the shaft element then generates an orbiting movement of the crank pin, which converts the rotational movement of the shaft element to a reciprocating movement of a piston. For this purpose, the crank pin is connected to the piston of the plunger piston compressor via a connecting rod.

Usually such crankshafts are forged or cast. After manufacturing a blank, the crankshaft blank has to be ground, at least in the areas, in which a relative movement takes place between a rotating element and a non-rotating element during operation. This is particularly the case for the shaft element, as the shaft element is normally used for supporting the crankshaft. Traditional crankshafts for refrigerant compressors are often made of cast iron and have to undergo an expensive machining treatment before the grinding.

The grinding of such crankshafts is usually a centre-less grinding process. After insertion in the grinding machine, the crankshaft is ground between a rotating grinding disc and an equally rotating contact roller, whose rotation axis is slightly sloped in relation to the rotation axis of the grinding disc. The contact roller ensures that in the axial direction the crankshaft is pulled forward to a predetermined position. Due to the relatively inaccurate insertion position, however, a certain axial distance between the transition element and the ground section of the shaft element has to be observed. This again causes a relatively large axial distance between the crank pin and the position, on which the shaft element can be radially supported. This results in a relatively large lever arm between the crank pin and the possible supporting point being closest to the crank pin.

A further disadvantage occurs in that on a whole the accuracy of the grinding process is small. If it is desired to increase the accuracy, substantial additional costs are involved. Further, the grinding tool can only be moved towards the shaft section at a relatively low speed, so that relatively large fixed-cycle times occur.

### SUMMARY OF THE INVENTION

The invention is based on the task of keeping the manufacturing costs of the crankshaft low.

With a compressor crankshaft of the kind mentioned in the introduction, this task is solved in that along its circumference the transition element has at least one first reference point and one second reference point, with which the transition element can be positioned in a holding fixture of a working machine.

If it is desired to grind such a crankshaft on its shaft element, the crankshaft blank can be inserted in the working machine and positioned very accurately by means of the transition element. The transition element has at least two reference points, so that a positioning is possible in two directions. With a positioning in two directions, the transition element can, however, be positioned so that the shaft axis, for example the axis of the shaft element, corresponds to the rotation axis of the grinding machine. When, now, the position of the shaft element has been fixed in this way, the grinding disc can relatively quickly be engaged on the shaft section. A grinding disc can be chosen to determine the contour of the shaft section. When, during grinding, the crankshaft is held on the transition element, a centre-less grinding no longer has to be used, which improves the accuracy of the working.

Preferably, the transition element has at least one third reference point on a front side. Thus, it is possible also to use the transition element for an exact axial positioning of the crankshaft during grinding. The exact axial fixing causes that the grinding tool can be narrowed closer to the side of the transition element, on which the shaft element is located. This also applies, if the transition element already has one worked surface serving in the assembled state as an axial bearing surface. Further, no lateral forces occur on the grinding tool, so that the grinding tool has a longer life. Also, a larger axial length of the radial bearing surfaces on the shaft element is maintained, as also the area immediately next to the axial bearing can be used as bearing surface. This improves the bearing properties. At the same time, the axial distance between the radial bearing on the shaft element and the crank pin, that is, the contact point of the connecting rod on the crankshaft, is reduced. This reduces the forces transferred to the crankshaft from the piston and the connecting rod, which have to be adopted by the radial bearing.

Preferably, the third reference point is located on the front side, on which the crank pin is located. This facilitates the positioning. If the shaft element is ground, the crankshaft can, in a manner of speaking, be inserted together with the transition element into a holding fixture until the stop, the stop interacting with the third reference point to secure an exact axial position of the crankshaft.

Preferably, the second reference point is made of two reference surfaces, which are located on both sides of a longitudinal axis of the transition element, particularly on oppositely located sections of the circumference. It is not required that the oppositely located sections extend in parallel to each other. However, in a manner of speaking, they permit the working machine to grip the transition element in a tong-like manner, which enables an exact positioning in one direction in a simple manner. The reference surfaces do not have to be large. However, it is an advantage, if they are so large that they can adopt the holding forces, with which the crankshaft is held in the holding fixture.

It is preferred that the reference surfaces enclose an angle. Thus, some kind of fitting wedge occurs, which can be gripped by corresponding counter-surfaces in the holding fixture of the working machine to position the transition element and thus also the crankshaft in the working machine.

This is particularly the case, if the angle opens in the direction of the first reference point. This enables the use of a holding fixture using a fixed part, on which the first reference point is positioned, and a second, movable part, which interacts with the second reference point. If, now, the second element is moved in the direction of the fixed, first element, a positioning of the transition element by means of the first reference point and the two, second reference points occurs automatically. The transition element is positioned and held by some kind of tongs.

Preferably, the crank pin and the first reference point are located on opposite sides of the shaft element. Thus, the crank pin will not influence the positioning. First and foremost, it will not cover the view of the first reference point for an operator.

Preferably, in the area of the end facing away from the transition element the shaft element has a diameter reduction. A clamping element can engage this diameter reduction, the fixing element fixing the crankshaft in the holding fixture. As mentioned above, the axial position occurs by means of the third reference point. The diameter reduction of the shaft element then provides an additional surface, which the fixing element can engage. As such a diameter reduction is usually conical; the fixing element can also be equipped with conical sides, so that also at this end of the shaft element a centering will occur during the axial clamping. The shaft element can be gripped on the circumference without causing a grinding of the fixing element.

Preferably, the shaft element is made up of two sections assembled in a telescope-like manner. Before grinding, the two sections can be fixedly assembled, for example by means of welding. When sections assembled in a telescope-like manner are used, different crankshafts can be made from the same elements, particularly such crankshafts, whose shaft element lengths differ. This is a further contribution to the reduction of the manufacturing costs.

Preferably, the transition element has a shaft pin on the side opposite the crank pin, said shaft pin being inserted into the shaft element. Thus, the shaft element and the transition element can be made as separate parts and then simply be joined in that the shaft pin is inserted into the shaft element and connected thereto, for example also by welding. As this connection is made before the grinding, it is uncritical.

Preferably, the transition element is made as a sintered or extrusion moulded part. Both a sintered part and an extrusion moulded part, particularly a cold formed part, can be manufactured with a very high accuracy, so that for making the reference points usually a subsequent working of the transition element will not be required.

With a method as mentioned in the introduction, the task is solved in that the crankshaft with the transition element is clamped in the holding fixture of a grinding machine, the transition element having on its circumference at least one first reference point and one second reference point for the positioning in the holding fixture.

If the transition element is used to retain the crankshaft in the grinding machine, the crankshaft, particularly the shaft element of the crankshaft, can be held with a very high accuracy in a predetermined position during grinding, so that the shaft element can be ground with a very high accuracy. Positioning by means of two reference points causes that the axis of the shaft element and the rotation axis of the grinding machine correspond to each other, so that a highly accurate crankshaft can be manufactured with a relatively small amount of cut material.

Preferably, a movable element of the holding fixture that presses on the transition element in the area of the second reference point, presses the transition element with its first reference point against a stationary section of the holding fixture. Thus, the second reference point is not only used for positioning purposes, but also for moving the transition element and holding it during grinding.

Preferably, a third reference point on the transition element is used to position the crankshaft in the axial direction. Thus, it is possible to guide the shaft element so accurately that it can be ground over the major part of its axial length, also in the immediate vicinity of the transition element. This means that the transition element can already be provided with an axial bearing surface without risking that this axial bearing surface is damaged during grinding of the shaft element.

Preferably, a clamping element is used for the axial positioning, said element acting upon the end of the shaft element facing away from the transition element in a section of the shaft element with reduced diameter. The clamping element can act upon a conical section of the shaft element, so that the clamping element can be used during grinding, not only to hold the shaft element in the axial direction, but also to centre the shaft element. This further improves the accuracy during grinding of the shaft section without increasing the costs significantly.

### BRIEF DESCRIPTION OF THE DRAWINGS

In the following the invention is described in detail on the basis of a preferred embodiment in connection with the drawings, showing:

FIG. 1 is a sectional view of a crankshaft;

FIG. 2 is a perspective view of the crankshaft;

FIG. 3 is a top view of the crankshaft;

FIG. 4 is a side view of the crankshaft; and

FIG. 5 shows an arrangement for grinding the shaft element section of the crankshaft.

### DETAILED DESCRIPTION OF THE INVENTION

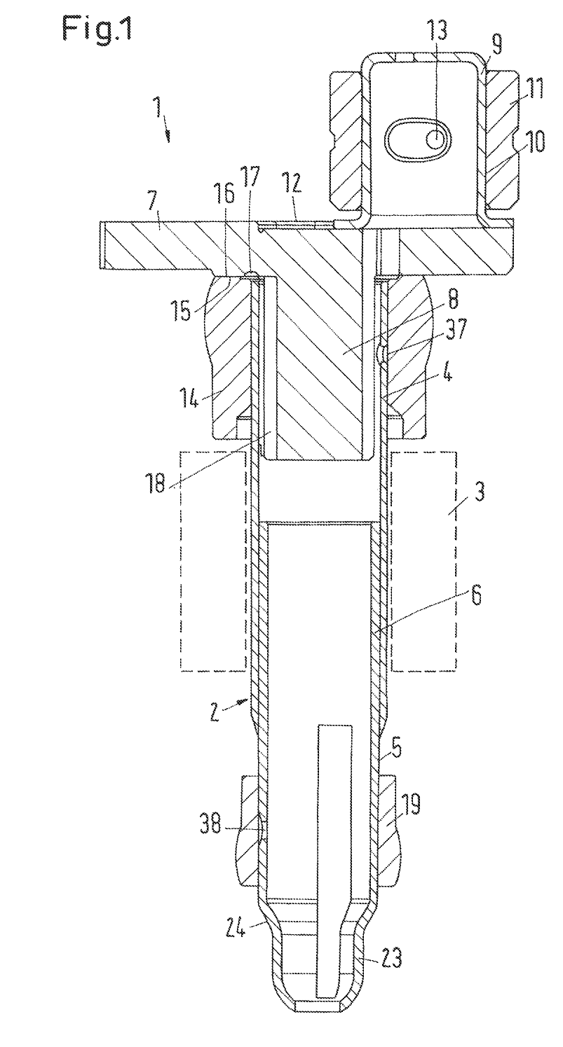

A crankshaft 1 of a refrigerant compressor shown in FIG. 1 has a shaft element 2, which is designed to be connected to a merely schematically shown rotor 3 of an electrical drive motor. The shaft element 2 is made of two telescopically joined sections 4, 5, which are connected to each other, for example by welding, in an overlapping section 6.

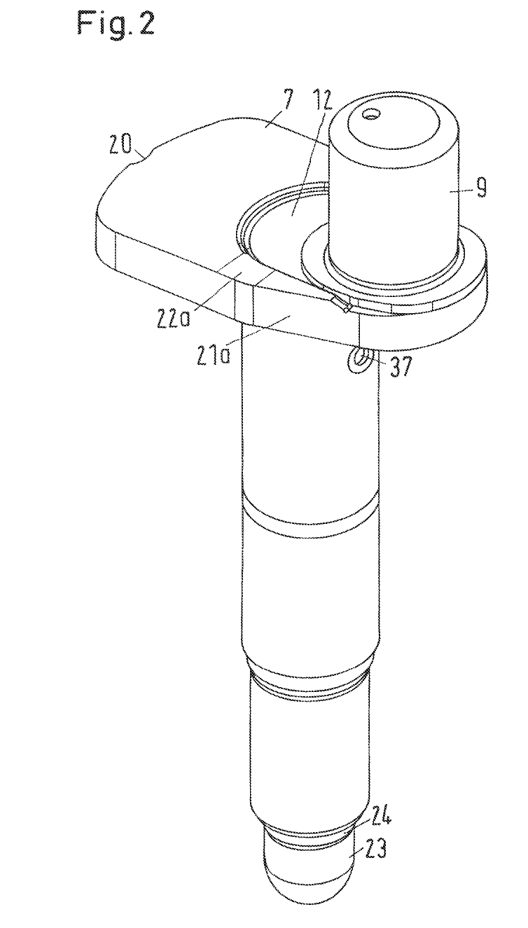

Such a crankshaft 1 is usually driven in the shown position, in which the shaft element is substantially vertically oriented. For reasons of simplicity directions will in the following be called “up” or “down” and the like, said terms referring to the views in FIGS. 1, 2 and 4. However, no definite spatial fixing of the crankshaft 1 is given.

A transition element 7 is located at the upper end of the section 4 of the shaft element 2. The transition element 7 is made as a sintered or extrusion moulded part, particularly a cold formed part. It can therefore be made with a high accuracy, without requiring further working steps for making the exact dimensions.

The transition element 7 has a shaft pin 8, which is inserted in the upper section 4 of the shaft element 2. The whole shaft element 2 is made to be hollow.

On the side facing away from the shaft element 2 is located a crank pin 9, whose circumferential surface 10 forms a connecting rod bearing for supporting a connecting rod 11, which does, in a manner not shown in detail but known per se, reciprocates a piston in a cylinder of the compressor.

Like the two sections 4, 5 of the shaft element the crank pin 9 is a deepdrawn part. The crank pin 9 is located in a recess 12 on the upper side of the transition element. In its circumferential wall 10 it has an oil discharge opening 13 for lubrication of the bearing with the connecting rod 11.

The shaft element 2 is radially supported in an upper bearing block 14, the bearing block 14 also forming a bearing surface 15 for an axial bearing. On this bearing surface 15 the transition element 7 rests with an axial bearing surface 16. As an extension to the shaft element 2 the transition element has a recess 17, through which oil can reach the axial bearing between the two surfaces 15, 16 from the inside of the shaft element 2 and through axial channels 18 formed between the shaft pin 8 and the shaft element 2.

At the lower end the shaft element 2 is supported in a lower bearing block 19, the bearing block 19 merely serving the purpose of a radial bearing.

For manufacturing such a crankshaft 1, the shaft element 2, the transition element 7 and the crank pin 9 are made as separate parts. As mentioned above, the transition element 7 is a sintered or extrusion moulded part, so that after manufacturing it already has a sufficiently high accuracy. The transition element 7 and the shaft element 2 are connected to each other. The crank pin 9 is connected to the transition element 7. Subsequently, both the shaft element 2 and the crank pin 9 must be ground in a way that the circumferential wall 10 of the crank pin 9 extends in parallel to the rotation axis of the shaft element 2, which again is aligned in parallel to the radial bearing surfaces in the bearing blocks 14, 19. Accordingly, the shaft element must be ground, at least in the area of the sections, in which the radial bearings of the bearing blocks 14, 19 will eventually be located.

To perform such a grinding process with as high accuracy as possible, the transition element 7 has several reference points. A first reference point 20 is located at an end of the transition element 7 opposite to the crank pin 9. The first reference point 20 is formed by a recess in the circumferential wall of the transition element 7.

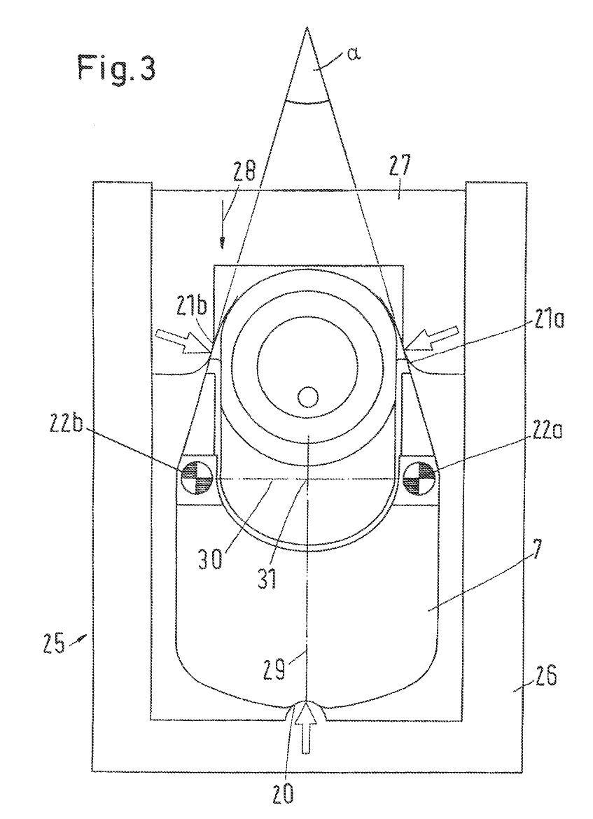

A second reference point 21a, 21b (FIG. 3) is also located in the circumferential wall of the transition element 7. The second reference point 21a, 21b is formed by two reference surfaces opposite to each other and enclosing an angle a that opens in the direction of the first reference point 20.

A third reference point 22a, 22b is formed on the upper side of the transition element, that is, on the side, on which also the crank pin 9 is located. Also the third reference point 22a, 22b is formed by two surfaces, which are, however, in one level. They are located next to the recess 12.

At its lower end, that is, at the end facing away from the transition element 7, the shaft element 2 has a diameter reduction 23 that widens across a cone surface 24 towards the transition element 7.

As appears from the FIGS. 3 to 5, such a crankshaft can now be positioned very accurately in a holding fixture 25 of a working machine, particularly a grinding machine. As shown in FIG. 3, the holding fixture has a fixed element 26 and a movable element 27 that can be moved towards the fixed element 26 in a clamping direction 28.

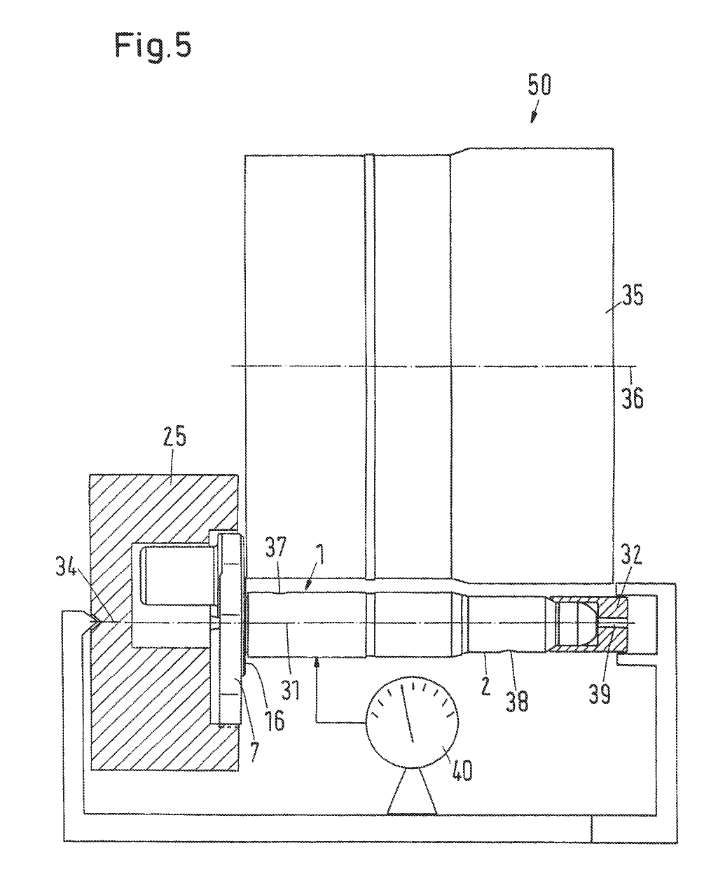

To position the transition element 7 in the level shown in FIG. 3, the transition element with its first reference point 20 is positioned in the fixed element 26. The movable element 27 seizes the transition element 7 at the two reference points 21a, 21b. Thus, the transition element 7 is centred, that is, aligned so that a longitudinal axis 29 takes a predetermined position, for example in parallel to the clamping direction 28. Due to the inclination of the two surfaces forming the second reference point 21, the movable element 27 can also exert a clamping force in the clamping direction 28, so that a transversal axis 30 connecting the two second reference points 21a, 21b to each other will also take a predetermined position due to the interaction of the first reference point 20 with the second reference point 21. Due to the determination of the longitudinal axis 29 and the transversal axis 30, a central axis 31 of the transition element 7, which corresponds to the central axis of the shaft element 2, will be positioned so that the central axis 31 corresponds to the rotation axis 34 (FIG. 5) of a grinding machine 50.

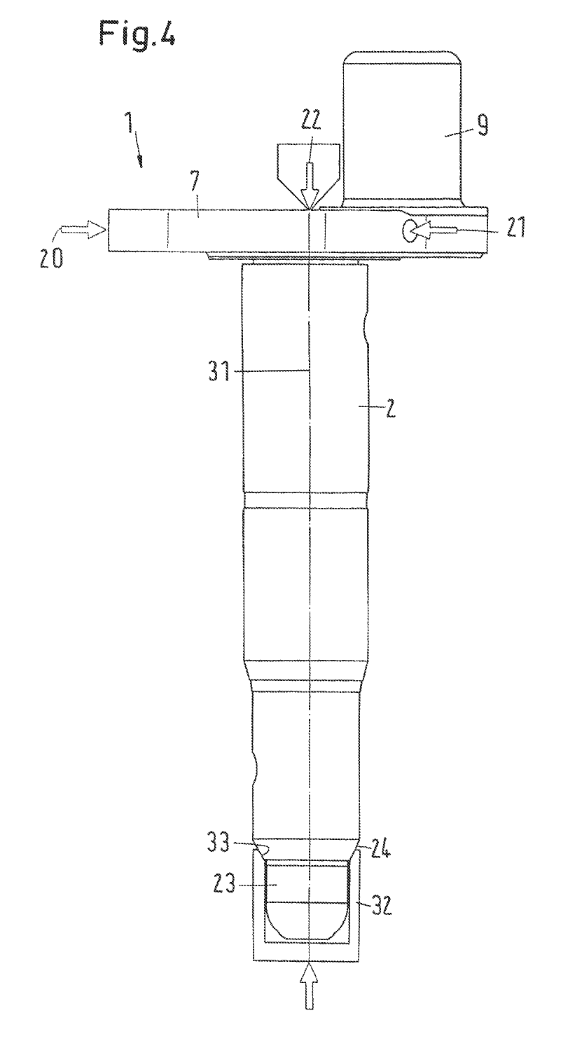

As can be seen from the FIGS. 4 and 5, the crankshaft 1 is at the same time pressed in the axial direction into the holding fixture 25 by a clamping element 32, so that the third reference point 22 bears on the holding fixture 25 in the axial direction. Thus, the crankshaft 1 is fixed very accurately in the holding fixture in three spatial directions. An additional centering occurs in that the clamping element 32 has a conically shaped front side 33 that acts upon the cone surface 24, which represents transition of the diameter reduction 23 into the rest of the shaft element 2.

FIG. 5 shows a schematic view of the grinding machine 50, in which the holding fixture 25 is rotatable around the rotation axis 34. For reasons of clarity, a motor required for this purpose is not shown. The crankshaft is held by the holding fixture 25 and the clamping element 32 located at the other end. The holding fixture 25 seizes the transition element 7. The clamping element 32 rotates together with the crankshaft 1. This means that there is no relative movement between the clamping element 32 and the shaft element 2.

A grinding disc 35 having the contour of the crankshaft 1, or rather, of the shaft element 2, rotates around an axis 36. The axis 36 can, but does not necessarily have to, extend exactly in parallel to the rotation axis 34. Thus, the complete shaft element 2 can be ground, except for the section held by the clamping element 32. Due to the highly accurate axial fixing, the grinding disc 35 can be taken very close to the transition element 7 without risking to damage the axial bearing surface 16. This means that the axial bearing surface 16 can be worked before joining the transition element 7 and the shaft element 2.

The exact positioning of the crankshaft 1 by means of the reference points 20-22 formed on the transition element 7 enables a very fast radial approach of the grinding disc 35. When using deep-drawn pipe parts for the manufacturing of the shaft element 2, which parts can be manufactured very exactly, only very little refinishing is required. Thus, the grinding process can take place at very short fixed-cycle times.

Preferably, during grinding the shaft element 2 can be supplied with cooling or rinsing fluid that can be discharged through the radial bores 37, 38 available in the shaft section 2, which bores will later be used for the lubrication of the radial bearing, and through the axial openings at the top or the bottom of the transition element 7. The supply of this fluid takes place through an axial opening 39 in the clamping element 32. This enables a better cooling of the shaft element 2 during grinding and an improved removal of grindings from the crankshaft 1. In particular, it can be prevented that grindings settle inside the shaft element 2, which are usually difficult to remove.

Further shown is a measuring device 40 for the current control of the outer diameter of the shaft section 2 of the crankshaft 1. This enables an active monitoring of the grinding process and an accurate control of the grinding disc 35, for example, a current readjustment corresponding to the wear of the grinding disc 35.

Instead of the grinding disc shown, whose outer contour corresponds to the contour of the shaft element, also a grinding disc can be used that is moved in the axial direction across the shaft element 2 during grinding, the contour of the shaft element 2 then being developed by control of the radial movement of the grinding disc.

The fact that the grinding disc 35 can be brought very close to the bottom side of the transition element 7 makes it possible to grind the shaft element 2 up to an area, which is very close to the transition element 7. Accordingly, the radial bearing can also be located very close to the transition element 7, so that leverage forces of the crank pin 9 acting upon the radial bearing can be kept small.

While the present invention has been illustrated and described with respect to a particular embodiment thereof, it should be appreciated by those of ordinary skill in the art that various modifications to this invention may be made without departing from the spirit and scope of the present invention.

What is claimed is:

1. A compressor crankshaft, particularly a refrigerant compressor crankshaft, with a shaft element, a crank pin located eccentrically to the shaft element and a transition element between the shaft element and the crank pin, wherein along its circumference the transition element has at least one first reference point and one second reference point, with which the transition element can be positioned in a holding fixture of a working machine.

2. The compressor crankshaft according to claim 1, wherein the transition element has at least one third reference point on a front side.

3. The compressor crankshaft according to claim 2, wherein the third reference point is located on the front side, on which the crank pin is located.

4. The compressor crankshaft according to claim 1, wherein the second reference point is made of two reference surfaces, which are located on both sides of the longitudinal axis of the transition element.

5. The compressor crankshaft according to claim 4, wherein the reference surfaces are formed on oppositely located sections of the circumference.

6. The compressor crankshaft according to claim 5, wherein the reference surfaces enclose an angle α.

7. The compressor crankshaft according to claim 6, wherein the angle α opens in the direction of the first reference point.

8. The compressor crankshaft according to claim 1, wherein the first reference point is formed in a recess in the circumference.

9. The compressor crankshaft according to claim 1, wherein the crank pin and the first reference point are located on opposite sides of the shaft element.

10. The compressor crankshaft according to claim 1, wherein in the area of the end facing away from the transition element the shaft element has a diameter reduction.

11. The compressor crankshaft according to claim 1, wherein the shaft element is made up of two sections assembled in a telescope-like manner.

12. The compressor crankshaft according to claim 1, wherein the transition element has a shaft pin on the side opposite the crank pin, said shaft pin being inserted into the shaft element.

13. The compressor crankshaft according to claim 1, wherein the transition element is made as a sintered or extrusion moulded part.

14. A method for grinding a compressor crankshaft, particularly a refrigerant compressor crankshaft, with a shaft element, a crank pin and a transition element between the shaft element and the crank pin, the circumference of the shaft element being ground wherein the crankshaft with the transition element is clamped in the holding fixture of a grinding machine, the transition element having on its circumference at least one first reference point and one second reference point for the positioning in the holding fixture.

15. The method for grinding a compressor crankshaft according to claim 14, wherein a movable element of the holding fixture that presses on the transition element in the area of the second reference point, presses the transition element with its first reference point against a stationary section of the holding fixture.

16. The method for grinding a compressor crankshaft according to claim 14, wherein a third reference point on the transition element is used to position the crankshaft in the axial direction.

17. The method for grinding a compressor crankshaft according to claim 16, wherein a clamping element is used for the axial positioning, said element acting upon the end of the shaft element facing away from the transition element in a section of the shaft element with reduced diameter.
